(19) United States
(12) Patent Application Publication
(10) Pub. No.: US 2010/0072331 A1
(43) Pub. Date: Mar. 25, 2010

(54) Suitcase Handle Camera Mount

(75) Inventors: Priscilla Barton, Berkeley, CA (US); Kevin Crandall, Santa Rosa, CA (US)

Correspondence Address: MANATT PHELPS AND PHILLIPS;ROBERT D. BECKER, 1001 PAGE MILL ROAD, BUILDING 2, PALO ALTO, CA, 94304, US

(73) Assignee: Daymen Photo Marketing LP, Sebastopol, CA (US)

(21) Appl. No.: 12/235,502

(22) Filed: Sep. 22, 2008

(51) Int. Cl. F16M 11/00

(52) U.S. Cl. 248/176.1

(57) ABSTRACT

The invention relates generally to mounts, stands and support attachments for cameras and similar devices. More specifically, a suitcase optimized for cameras and camera accessories is integrated with a handle adapted for use as a camera mount.

### RELATED APPLICATIONS

This application is related to the following co-pending applications, with some common inventors, and the same assignee. The teaching of the following applications listed below are herein incorporated by reference:

U.S. application Ser. No.: not yet assigned, filed Sep. 22, 2008, entitled “Suitcase with Integrated Pull-Out Backpack.”

U.S. application Ser. No.: not yet assigned, filed Sep. 22, 2008, entitled “Suspension Divider Insert.”

### BACKGROUND OF THE INVENTION

1. Field of the Invention

The invention relates generally to mounts, stands and support attachments for cameras and similar devices.

2. Background of the Invention

The following list provides examples of devices capable of utilizing a tripod or stabilizing mount: camera, flashes, video recorders, civil engineering equipment for leveling and surveying, laser equipment for tracking, optical equipment, astronomical equipment, telescopes, binocular, lab equipment, calibration equipment, lighting equipment, reflective devices, shading devices, and monitoring equipment. It should be noted that the list of devices above is not an exhaustive list of devices that can be utilized with the invention. The invention described herein can apply to usage with each of the above, and the teaching is the same for each application, but for the sake of simplicity, the invention is further described in detail for usage with cameras, camera equipment and accessories.

Many professional photographers find that a tripod is a useful accessory in their daily work. With sports photographers, a tripod or monopod is necessary to support the weight of large lenses, for example, 500 and 600 mm lenses. With night photography, for example, well lit night-time shots are extremely difficult to achieve without the use of a tripod or other stabilizing mount. In other instances, it provides a photographer with hands-free or remote usage of the mounted equipment, for example with flashes, lighting, or calibration equipment. The tripod or mount is a useful, if not essential piece of equipment for the professional and serious amateur photographers.

The camera bag or camera suitcase is also a useful piece of equipment for photographers. A suitcase, for example, is used to store, protect, and organize a photographer's camera equipment and accessories, and as such, is also an essential component to the professional or avid amateur photographer. Therefore, a combination of the two, a suitcase with an integrated camera mount provides two pieces of useful equipment in a single unit.

### SUMMARY OF THE INVENTION

In accordance with one embodiment of the present invention, a suitcase optimized for cameras and camera accessories is integrated with a handle adapted for use as a camera mount.

In accordance with another embodiment of the present invention, a suitcase is integrated with a retractable handle adapted for use as a camera mount in combination with a set of wheels to facilitate mobility.

In accordance with yet another embodiment of the present invention, a suitcase is integrated with a handle adapted for use as a camera mount in combination with an attached telescoping foot to provide additional stability for the mounted camera.

In accordance with yet another embodiment of the invention, a suitcase handle is integrated with a photographer's tripod. In this embodiment, the handle is fixed to a tripod, with the tripod positioned as to replace the suitcase trolley system. The tripod is therefore removable from the main suitcase, enabling its independent usage. In this way, the user is able to utilize a weight and space savings by eliminating the excess trolley system.

In accordance with yet another embodiment of the invention, the handle mount mechanism detaches and contains the mechanical members of a small fold-out travel tripod.

### BRIEF DESCRIPTION OF THE DRAWINGS

The drawings illustrate the design and utility of embodiments of the invention, in which similar elements are referred to by common reference numerals and in which:

FIGS. 1A and 1B illustrates a suitcase handle with threaded mounting hole and a camera mounting accessory in accordance with one embodiment of the invention.

FIG. 2 illustrates a suitcase handle mount with a mounted camera in accordance with one embodiment of the invention.

FIG. 3 illustrates a suitcase with retractable handle mount with a mounted camera in accordance with one embodiment of the invention.

FIGS. 4A and 4B illustrates a suitcase with pivoting and telescoping prop foot in accordance with one embodiment of the invention.

FIG. 5A-D provides examples of different embodiments of the suitcase handle mount within the scope of the present invention.

### DETAILED DESCRIPTION

Various embodiments of the invention are described herein with reference to the figures. It should be noted that the figures are not drawn to scale and elements of similar structures or functions are represented by like reference numerals throughout the figures. It should also be noted that the figures are only intended to facilitate the description of specific embodiments of the invention. The embodiments are not intended as an exhaustive description of the invention or as a limitation on the scope of the invention. In addition, an aspect described in conjunction with a particular embodiment of the invention is not necessarily limited to that embodiment and can be practiced in any other embodiment of the invention.

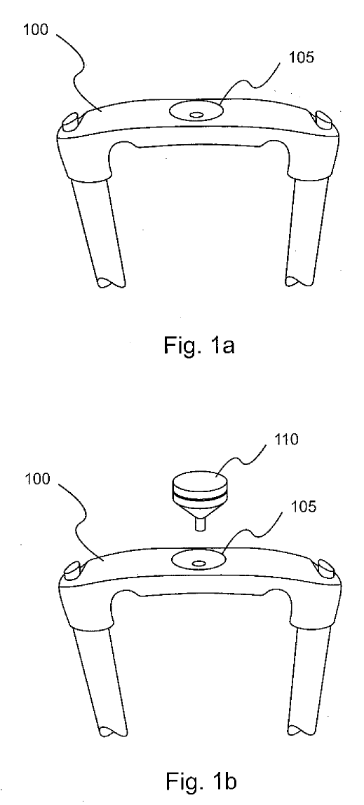

Turning to the drawings, FIG. 1A illustrates a suitcase handle 100 with a mount hole 105 in accordance with one embodiment of the invention. The mount hole 105 is built into the handle in accordance with one embodiment of the invention. The mount hole 105 utilizes universal threading in a one-quarter inch screw (¼-20 mount screw), common in the industry for use with cameras, camera accessories, and other devices featuring universal mounting members. Alternatively, the mount hole 105 may feature engaging means other than a threaded hole, including but not limited to the following: magnetic mechanism, buckles, clips, snaps, latches, hooks, vacuum mechanism, adhesive mechanisms, locks, and cable ties.

The suitcase handle 100 is typical of suitcase handles well known in the travel bag industry, and can be molded or manufactured from a variety of materials to any desired shape and size. Although a suitcase handle 100 is shown, the handle can be adapted for use with any bag or case with a handle, including but not limited to the following: bags, satchels, purses, suitcases, hard cases, soft cases, backpacks, side packs, messenger bags, rolling duffle bags, and rolling backpacks. In accordance with one embodiment of the invention, the mount hole 105 can be optionally covered with a mount hole port cover to conceal the hole as desired for design and aesthetic purposes.

FIG. 1B illustrates a suitcase handle 100 with threaded mount hole 105 and a mounting adapter 110 in accordance with one embodiment of the invention. As shown, mounting adapter 110 features universal one-quarter inch screw and threading at both ends for attachment to mount hole 105, as well as to camera mounts and other devices featuring universal mounting members. As is the case with mount hole 105, although universal one-quarter inch screw and threading is illustrated for mounting adapter 110, mounting adapter 110 can be adapted to feature other engaging means, including but not limited to the following: magnetic mechanism, buckles, clips, snaps, latches, hooks, vacuum mechanism, adhesive mechanisms, locks, cable ties, and different sized and threaded screws.

It should be noted that while mount hole 105 and mount adapter 110 are shown as two separate components, it is contemplated the two elements can be combined into a single unit, adapted to be directly attached to camera mounts and other device mounts. This variation and others is described below as additional embodiments of the invention, and is within the scope of the present invention.

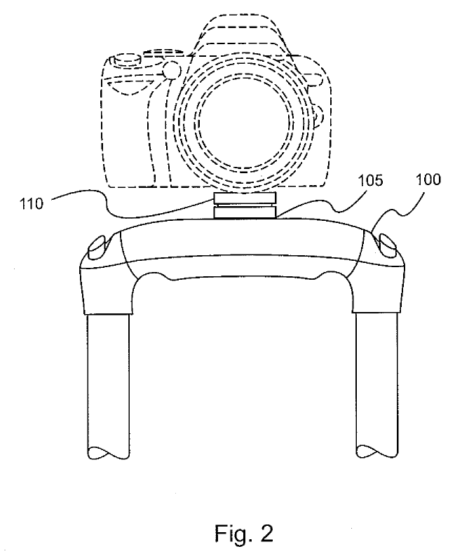

FIG. 2 illustrates a suitcase handle mount 100 with a mounted camera in accordance with one embodiment of the invention. One embodiment of the present invention is shown in use with a mounted single lens reflex (SLR) camera. Mounting adapter 110 is screwed into mount hole 105. The mounting adapter 110 is also screwed into the SLR camera mount hole. The in-use example of the present invention in FIG. 2 demonstrates various uses for the mount, including but not limited to, remote shooting, hands-free shooting, and long exposure shooting. While the mounting adapter 110 shown provides a single position for the mounted device, mounting adapter 110 can be adapted for use with a variety of mount heads, including but not limited to the following: pan and tilt heads with one or more levers, ball and socket heads, grip action ball and socket heads, panoramic heads, and gimbal heads.

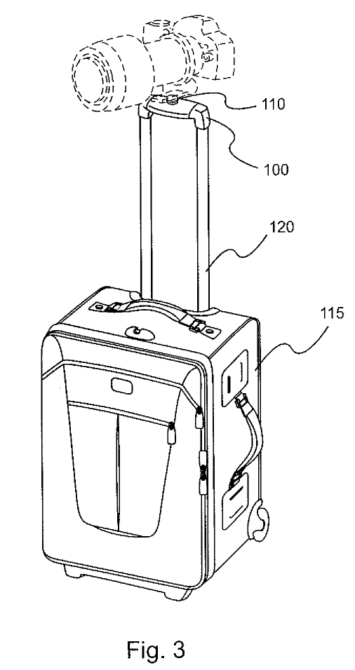

FIG. 3 illustrates a suitcase with retractable handle mount with a mounted camera in accordance with one embodiment of the invention. One embodiment of the present invention is shown in use with a mounted SLR camera. As shown, the suitcase 115 features suitcase handle 100 affixed to retracting mechanism 120 capable of being quickly and easily stored within a concealed compartment in suitcase 115. Additionally, FIG. 3 illustrates one end of mounting adapter 110 screwed into mount hole 105, and the opposite end of mounting adapter 110 screwed into the SLR camera mount hole. One advantage of the present invention is that it eliminates the need for a photographer to carry a tripod with his camera gear. The present invention stores and protects the photographer's gear in a mobile case while also serving as a universal mount.

It should be noted that while retracting mechanism 120 is shown as a single unit at a fixed height, it is contemplated retracting mechanism 120 can be moved to different levels or may be modified as a telescoping mechanism, capable of achieving heights at levels greater than twice the height of the suitcase or bag.

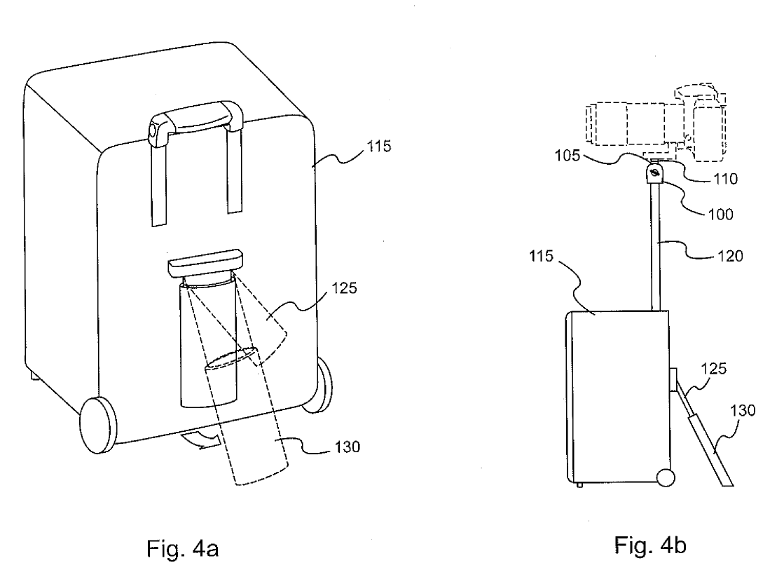

FIGS. 4A and 4B illustrates a suitcase with pivoting and telescoping prop foot in accordance with one embodiment of the invention. As illustrated in FIG. 4A, suitcase 115 features prop foot 125 affixed the backside. Prop foot 125 rests in a first position flush against suitcase 115 for storage when not in use. For use, prop foot 125 pivots and rotates away from suitcase 115, and telescoping foot member 130 pulls out and elongates to provide additional stability when oversized and/or heavy equipment is mounted on the suitcase handle. Although a single prop foot 125 is shown affixed to suitcase 115, multiple prop feet may be attached to provide the desired aesthetics or functionality.

FIG. 4B illustrates a suitcase with prop foot 125 in an open position with a mounted camera in accordance with one embodiment of the invention. As shown, one embodiment of the present invention is shown in use with a mounted SLR camera. The suitcase 115 features suitcase handle 100 affixed to retracting mechanism 120. Additionally, one end of mounting adapter 110 is screwed into mount hole 105, and the opposite end of mounting adapter 110 is screwed into a camera mount hole of a SLR camera with a large telephoto lens. Suitcase 115 also features prop foot 120. When in use, as shown, prop foot 120 is pivoted away from suitcase 115 and telescoping foot member 130 is fully extended to provide further stability for the mounted SLR camera.

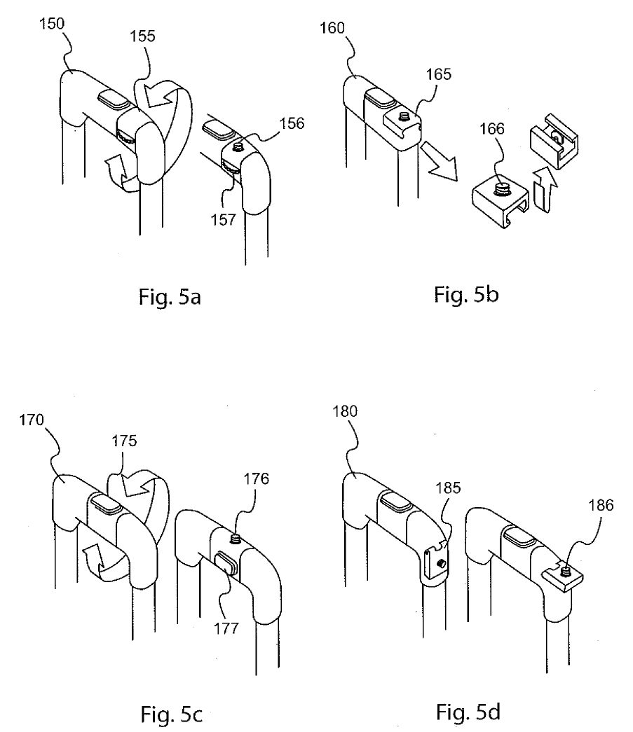

FIG. 5A-D provides examples of different embodiments of the suitcase handle mount within the scope of the present invention.

FIG. 5A illustrates a suitcase handle with a built-in mounting adapter in accordance with one embodiment of the invention. As shown in FIG. 5A, mounting adapter 155 is built into suitcase handle 150. Mounting adapter 155 features an integrated threaded mount screw 156 and integrated dial 157 for rotating the threaded mount screw. Additionally, mounting adapter 165 can be swiveled around to conceal the threaded mount screw when not in use.

FIG. 5B illustrates a suitcase handle with a built-in mounting adapter in accordance with one embodiment of the invention. As shown in FIG. 5B, mounting adapter 165 is built into suitcase handle 160. Mounting adapter 165 is molded specifically to fit and lock into an oppositely molded suitcase handle 160. Mounting adapter 165 also features an integrated threaded mount screw 166. The design allows mounting adapter 166 to be fixedly mounted to a camera or camera accessory, and yet, quickly and easily attached or detached from suitcase handle 160.

FIG. 5C illustrates a suitcase handle with a built-in mounting adapter in accordance with one embodiment of the invention. As shown in FIG. 5C, mounting adapter 175 is built into suitcase handle 170. Mounting adapter 175 features an integrated threaded mount screw 166. Additionally, mounting adapter 175 can be swiveled around to conceal the threaded mount screw when not in use. Mounting adapter 175 includes swivel button 177 that, when depressed, releases a lock that allows mounting adapter 175 to swivel.

FIG. 5D illustrates a suitcase handle with a built-in mounting adapter in accordance with one embodiment of the invention. As shown in FIG. 5D, mounting adapter 185 is built into suitcase handle 180. Mounting adapter 185 is a flip-out member that sits flush with suitcase handle 180 in a substantially vertical position when stored, and also, rotates away from the side of suitcase handle 180 to a substantially horizontal position when in use. Mounting adapter 185 features an integrated threaded mount screw 186.

What is claimed is:

1. A mounting device, comprising:
a suitcase; and
a suitcase handle, wherein said suitcase handle is adapted with a mount.

2. The mounting device of claim 1, wherein said mount is a universal camera mount adapted for ¼″-20 threaded screws.

3. The mounting device of claim 1, wherein said suitcase is adapted for storing camera equipment.

4. The mounting device of claim 1, wherein said suitcase handle is a retractable suitcase handle.

5. The mounting device of claim 4, wherein said retractable suitcase handle is a telescoping suitcase handle.

6. The mounting device of claim 1, wherein said suitcase further comprises:
a foot member attached to said suitcase backside.

7. The mounting device of claim 6, wherein said foot member comprises a telescoping member.

8. The mounting device of claim 7, wherein said foot member attached to said suitcase backside pivots and telescopes away from said wheel suitcase for stabilizing said mounting device.

9. A mounting system, comprising:
a carrier for storing equipment; and
a handle attached to said carrier, wherein said handle is adapted with a handle mounting hole.

10. The mounting system of claim 9, wherein said handle mounting hole is threaded for a ¼″-20 screw.

11. The mounting system of claim 9, further comprising a mounting adapter, wherein said mounting adapter comprises:
a first screw for engagement with said mounting hole; and
a second screw for engagement with a camera mounting hole.

12. The mounting system of claim 11 further comprising:
a prop foot, wherein said prop foot is connected to the body of said carrier for stabilizing said mounting system.

13. The mounting system of claim 12, wherein said prop foot comprises:
a pivoting element for rotating away from said body of said carrier; and
a telescoping member that extends to the ground when said pivoting element is fully rotated in an open position.

14. A mounting device, comprising:
a wheeled suitcase adapted for storing camera equipment;
a retractable suitcase handle for pulling said wheeled suitcase, wherein said handle is adapted with a mount for camera equipment; and
a foot connected to a back of said wheeled suitcase for stabilizing said wheeled suitcase.

15. The mounting device of claim 14, wherein said mount is a universal camera mount adapted for ¼″-20 threaded screws.

16. The mounting device of claim 14, wherein said retractable suitcase handle is a telescoping suitcase handle.

17. The mounting device of claim 14, wherein said retractable suitcase handle is stored in a compartment inside said wheeled suitcase.

18. The mounting device of claim 14, wherein said foot is a pivoting and extendable foot.

19. The mounting device of claim 14, wherein said pivoting and extendable foot comprises:
a pivoting element for rotating away from said body of said wheeled suitcase to an open position; and
a telescoping member that extends to the ground when said pivoting element is fully rotated to said open position.
